(19) United States
(12) Patent Application Publication
(10) Pub. No.: US 2011/0189060 A1
(43) Pub. Date: Aug. 4, 2011

(54) Improvements to Detergent Delivery Device

(75) Inventors: Dietmar Van Loyen, Ludwigshafen (DE); Emanuele Rossetto, Ludwigshafen (DE); Renato Gaj, Alessandria (IT); Marco Moro, Alessandria (IT); Paolo Savini, Alessandria (IT); Francesc Ardite Ayats, Barcelona (ES)

(73) Assignee: Reckitt Benckiser N.V., Hoofdorp (NL)

(21) Appl. No.: 13/058,271

(22) PCT Filed: Aug. 13, 2009
(86) PCT No.: PCT/GB09/01977

§ 371 Date: Apr. 20, 2011

(30) Foreign Application Priority Data
Aug. 16, 2008 (GB) 0815030.2

(51) Int. Cl. B01D 11/02

(52) U.S. Cl. 422/261

(57) ABSTRACT

The invention is an improvement to a multi-dosing detergent delivery device, the device being of a type comprising a housing (2) for receiving therein, in use, a cartridge (200) having a plurality X of chambers (210) each accommodating a detergent composition, a directing means (3, 34) to direct, in use, wash liquor selectively into a selected chamber (210) of the cartridge (200) to contact the detergent composition therein, an outlet to allow the detergent loaded wash liquor to exit the device and indexing means (100) for automatic movement of said cartridge (200) in use relative to said directing means (3, 34). The specific improvement to the device comprises a shutter mechanism (310, 320, 330) for blocking or obstructing passage of water/wash liquor from said directing means (3, 34) to the selected chamber (210) during part of a wash cycle so as to avoid a problem of detergent held within the chamber (210) from being washed out or diluted during a pre-wash cycle of a dishwasher.

The invention relates to improvements to a detergent delivery device. In particular, it concerns improvements to multi-dosing detergent delivery devices of the type used, for instance, within dishwashing machines where a detergent is dispensed automatically over a plurality of washing cycles without the requirement for a user to refill the device.

A number of devices are known for holding unit doses of a detergent composition or additive, such as detergent tablets, and for dispensing of such unit doses into a machine.

WO 01/07703 discloses a device for the metered release of a detergent composition or additive into a dishwashing machine having a number of separate sealed chambers for holding the detergent composition or additive and means for piercing the chambers, activated by conditions within the machine.

WO 03/073906 discloses a free standing device for dispensing multiple doses of detergent into a dishwasher. The device has a plate-like construction. A round blister pack having a plurality of doses arranged around its periphery is loaded into the pack. A winder is then rotated to load mechanical energy into the device sufficient to dispense more than one dose of detergent. A thermally operated latch then moves when the device is subjected to the elevated temperatures within the dishwasher and, in cooperation with a ratchet mechanism, moves the blister pack so that the next dose of detergent is ready for dispensing. In order to dispense the detergent, either the blister pack is pierced, or the dose is ejected from its compartment within the blister pack.

WO 03/073907 discloses a similarly shaped free standing dispensing device. In order to dispense detergent, a lever is manually operated to move a blister pack either to eject the detergent from a compartment within the blister pack, or to pierce the blister pack. A door or flap initially prevents wash liquor within the machine from accessing the exposed detergent. A bi-metallic strip is provided to move the door or flap when the device is exposed to the elevated temperatures during a washing cycle to allow access of the wash liquor to the exposed detergent thereby dispensing the detergent to the machine.

One particular device of great utility, which is the subject of PCT application WO/2008/053178 comprises a multi-dosing detergent delivery device, the device comprising a housing for receiving therein a cartridge having a plurality X of chambers each accommodating a detergent composition, a directing means to direct, in use, wash liquor selectively into a chamber of the cartridge to contact the detergent composition therein and an outlet to allow the detergent loaded wash liquor to exit the device, wherein the device further comprises indexing means for automatic movement of said cartridge, in use, relative to said directing means during and subsequent to a wash cycle so as to cause a neighbouring chamber to be in an exposed, ready to be used, position prior to a next washing cycle.

The above-mentioned device has a particularly refined automatic indexing mechanism for automatically advancing between doses of detergent and is particularly advantageous in that it can cope with the fact that a dishwasher machine may during a single cycle include intermediate cycles where temperatures may rise in an initial part of a cycle, then drop and subsequently rise again. In such situations other devices may “double dose” the detergent, whereas the device of WO/2008/053178 avoids this by the use of a thermally reactive element such as a wax motor which expands a wax canister during a heating phase of a washing cycle and contracts as it cools during and subsequent to a final cooling phase of said washing cycle. Here, the relatively slow reaction of the wax canister and the fact that a majority of movement of the indexing mechanism happens during a cooling cycle manages the situation of avoiding double dosing

To understand the operation of this prior art device in a little more detail, that device will now be described with reference to the accompanying drawings, in which:

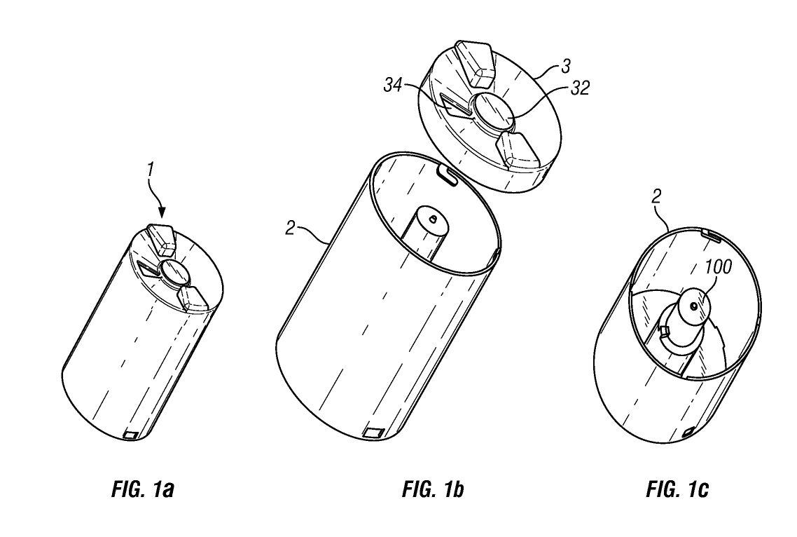

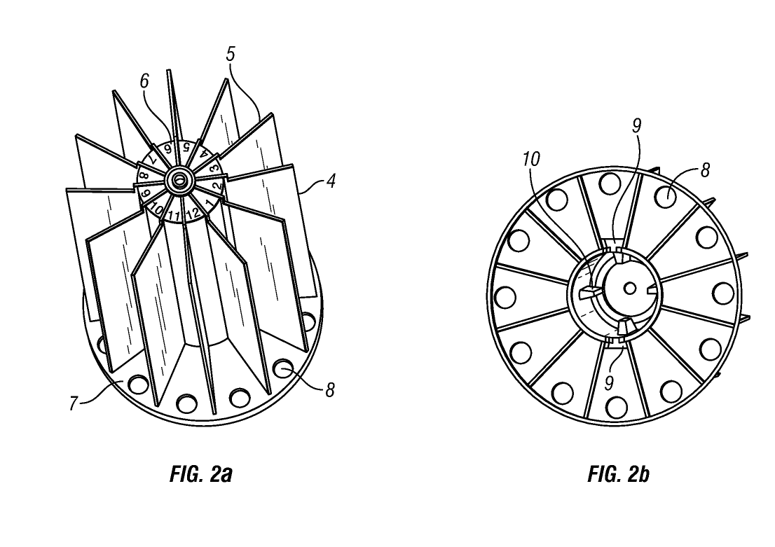

FIGS. 1(a), 1(b) and 1(c) are perspective assembled, perspective exploded and internal perspective views of a housing part and lid of the device of WO/2008/053178;

FIGS. 2(a) and (b) are schematic perspective views from above and from below showing a refill holder for use with the device of WO/2008/053178;

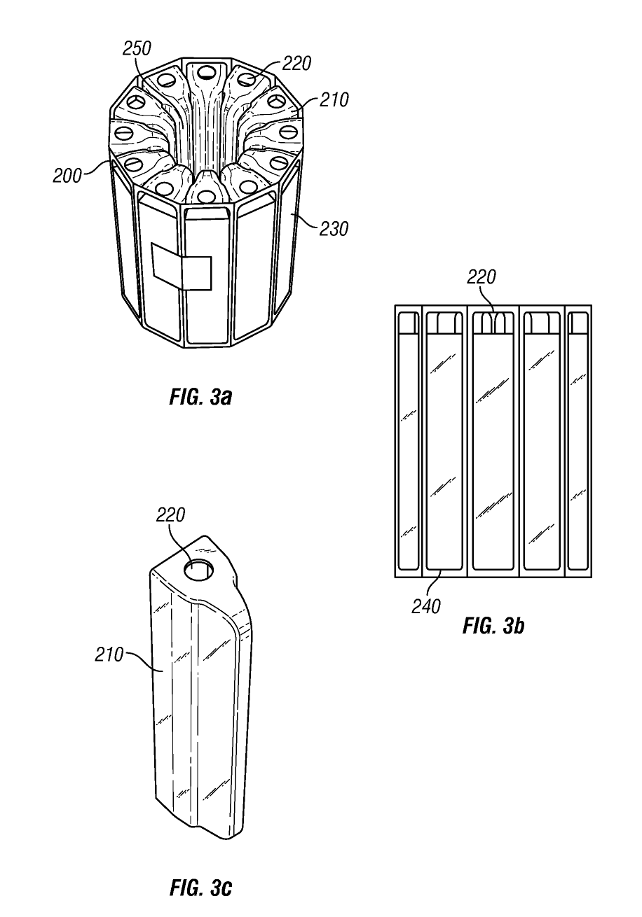

FIGS. 3(a) and 3(b) show a refill cartridge for use with the refill holder of FIGS. 2(a) and (b), whilst FIG. 3(c) shows a single chamber of a refill cartridge;

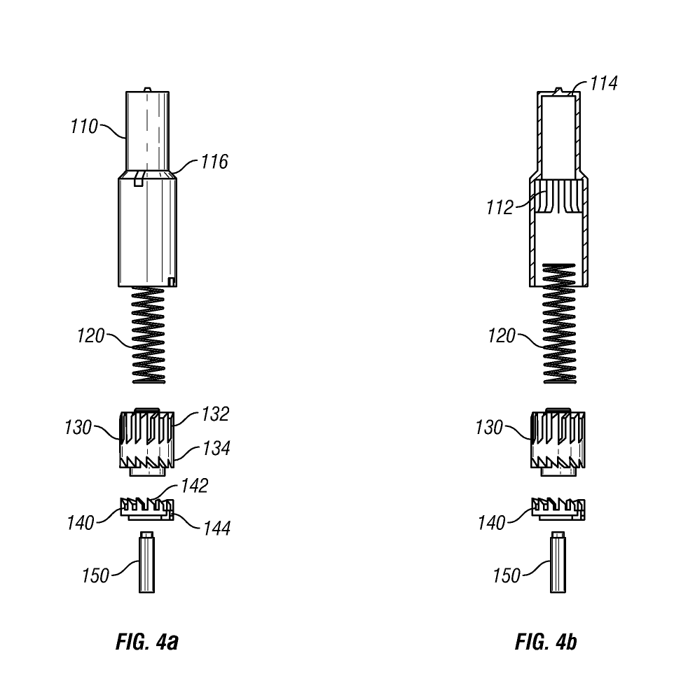

FIGS. 4(a) and 4(b) are perspective exploded and perspective partial assembly views of an automatic indexing mechanism of the device of WO/2008/053178;

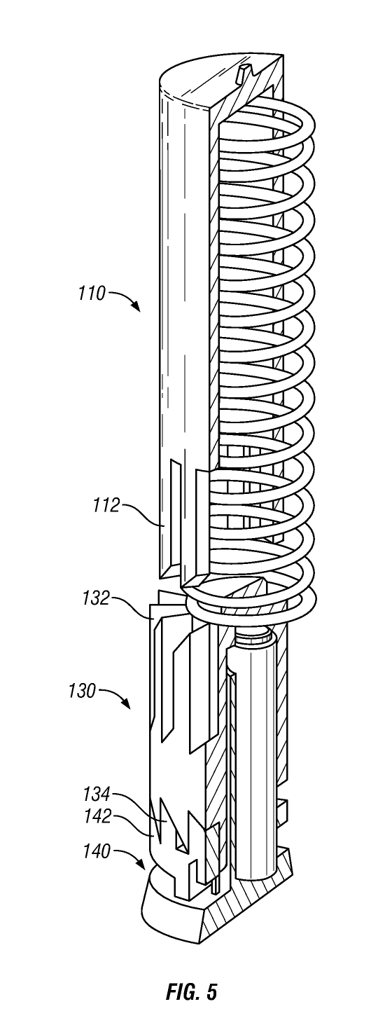

FIG. 5 shows in perspective cross-sectional view the automatic indexing mechanism of FIG. 4;

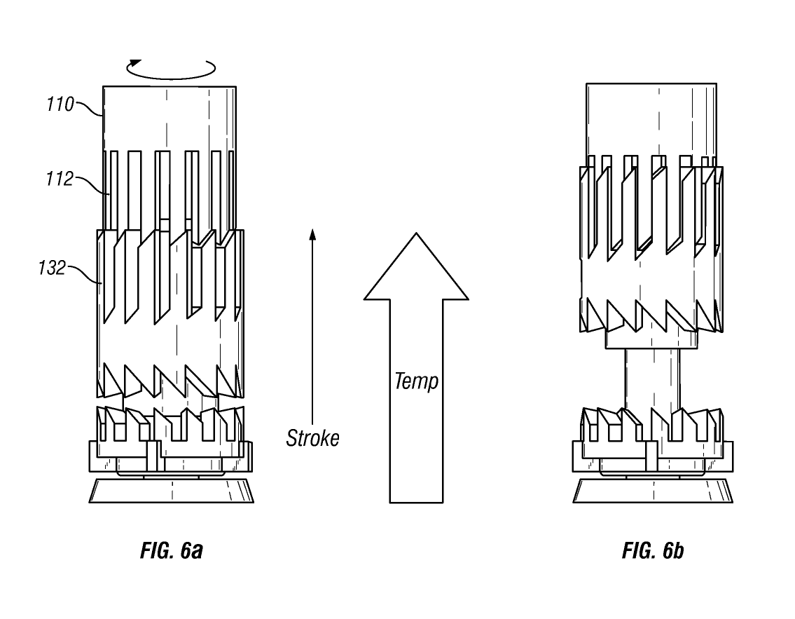

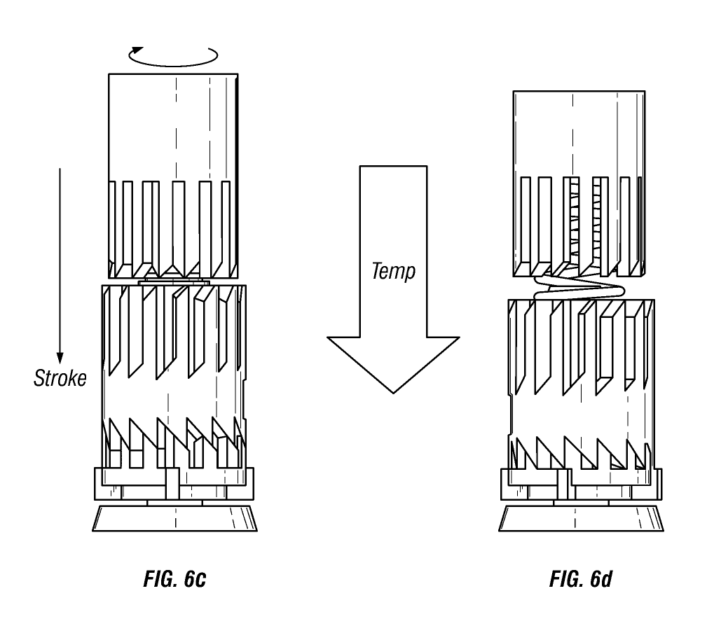

FIGS. 6(a) to 6(d) show the various states of the indexing mechanism of FIGS. 4 and 5 as temperature within an appliance utilising the device changes during a dishwashing cycle;

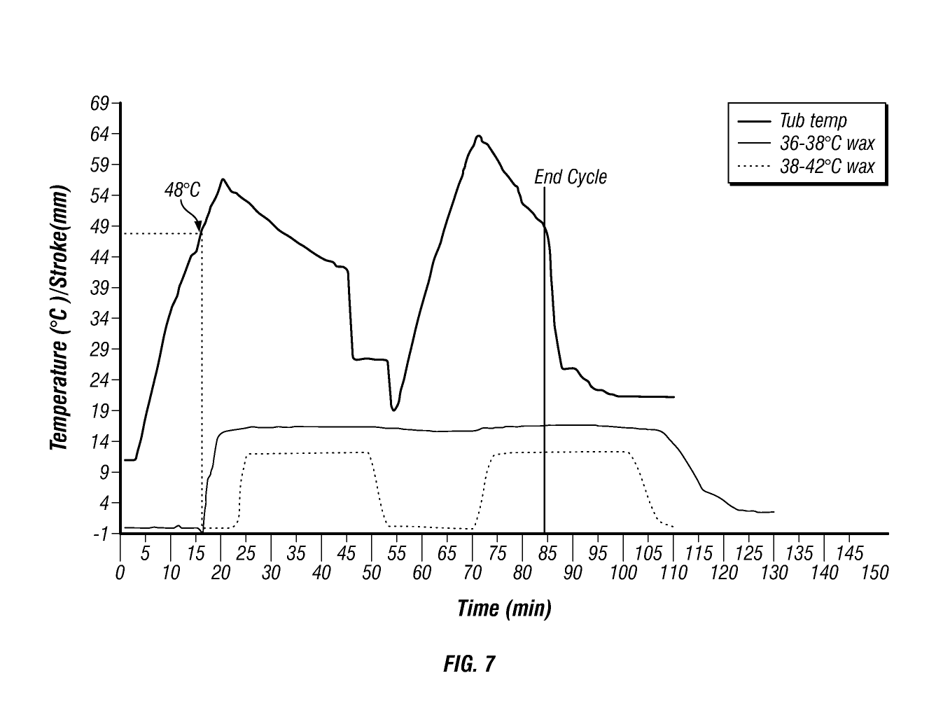

FIG. 7 shows a graph of temperature fluctuations over time during a typical dishwashing cycle and of the variations in activation state of a wax motor canister during the same period of time.

FIGS. 1(a), 1(b) and 1(c) show respectively perspective assembled, perspective exploded and internal perspective views of detergent dispensing device 1 comprising a housing 2 and a lid 3. The housing 2 has an indexing mechanism 100 housed within it and described later. The lid 3 has a window 32 to allow a user to see by means of a visual indicator a number of washes used or remaining for use with the device and also has directing means comprising an aperture 34 for directing wash liquor/water to the interior of the housing. The lid 3 has a general funnel like appearance to facilitate the collection of wash liquor/water available to the directing means.

The housing 2 is arranged to receive a refill holder 4 as shown in FIG. 2(a) which shows a refill holder in front perspective view and FIG. 2 (b) which shows the holder in bottom perspective view. The refill holder 4 comprises a plurality of dividing fingers 5 emanating from a central hub 6 and has a base 7 featuring a number of apertures 8 and lower location slots 9. Internally of the hub 6, there are formed one or more upper locating tabs 10 (four shown in the figure), whilst externally and at a central portion thereof there is provided numbering from 1 to 12 representing the number of washing cycles that an associated refill may have undergone or have remaining. The window 32 of the lid has a transparent portion that is, in use, aligned with the relevant sector of the numbered area.

The refill holder 4 is, in use, positionable within the housing 2 and the hub 6 has a hollow formation to co-operate with, and fit over, a central shaft 120 of the indexing mechanism 100 as will be described later.

The fingers 5 are arranged to co-operate with and register with internal spaces formed between parts of a disposable refill package 200 such as the one shown in FIGS. 3(a) and 3(b) and having individual chambers 210 as shown in FIG. 3(c). The refill package 200 is a cartridge that comprises a plurality of like chambers 210, and has a roll formation. The chambers 210 are separate from each other and comprise plastic sleeve or blister packages. The chambers 210 are spaced apart, having gaps between them that are apt to be engaged by the fingers 5 of the refill holder 4. Each chamber has an upper opening 220 and a lower opening 240 that is, in use, in register with one of the apertures 8 of the refill holder. Each chamber 210 is filled with sufficient cleaning composition for the completion of one dishwasher cycle. The contents of the chambers 210 are preferably in solid form and, therefore there is no problem with inadvertent spillage. There is also a central gap 250 in a central hub area that facilitates the placement of the refill 200 onto the refill holder 4.

Referring now to FIGS. 4(a) and 4(b) there is shown an indexing mechanism for automatically rotating the refill holder 100 and refill 200 of the device 1 relative to the housing 2 and lid 3.

The indexing mechanism 100 comprises a shaft 110, a spring 120, a cursor element 130, a cam 140 and a thermally reactive element that is preferably a wax motor 150.

The shaft 110 is hollow and receives the other components of spring, 120, cursor 130, cam 140 and wax motor 150 therein.

The shaft 110 has a closed end region 114 for providing a seat to the spring 120 and, approximately mid-way down a length of the shaft 110 there are formed internally a plurality of spaced apart downwardly depending straight parallel grooves 112, each of these grooves has a sloping lowermost portion as will be described presently.

The cursor 130 is locatable within the shaft 110 and, at its upper most portion provides a lower seating for the spring 120. It also has moulded thereon an upper and lower set of gear teeth 132, 134.

Cam element 140 is arranged for selective co-operation with the cursor element 130 and it too has an upper set of gear teeth 142 and has locating tangs 144 to locate it positively in use against refill holder 4. The cam element 140 has a central aperture to allow the wax motor element to sit within it.

Wax motor 150 comprises a wax can and a piston. Essentially, as wax is heated it expands and pushes against the piston, as it cools down, the wax contracts and, aided by spring action of the spring 120, the piston returns to its original position. In the device of the preferred embodiment, the wax motor sits at the bottom of the shaft 110 in the space provided by the central aperture of the cam element and the piston acts so as to cause the cursor 130 to rise and fall as appropriate during a heating/cooling cycle.

The inter-relation between all of the parts mentioned up to now will next be discussed.

Firstly, it will be appreciated that the housing 2, indexing mechanism 100 and the refill holder 4 are readily assembled into a single unit. Referring to FIG. 5, there is shown in a partial cut-away form a part of the shaft 110, the spring 120, cursor 130 and cam 140 all seated within the shaft 110. Here, the spring 120 seats against the internally closed top end of the shaft 110 and against the top of the cursor 130, whilst the wax motor 150 is positioned within the central aperture of the cam 140 and, at its lower end bears against a part of the base of the housing 2 and at its upper end against the cursor 130. The refill holder 4 is placed over the shaft 110 of the indexing mechanism and is located thereon by co-operation of its locating tabs 10 with corresponding formations in the form of locating slots 116. The refill holder also locates to the cam element 140 by co-operation between slots 9 and tangs 144, so that the shaft 110 and the cam 140 are locked to the refill holder 4.

Although not shown in the figures, the cursor element 130 is constrained such that it cannot rotate with respect to the holder 2, but it can be displaced in the vertical plane as such, it constitutes a linear element. The refill holder 4 on the other hand, is (once a refill 200 has been associated with it and the device 1 has been closed by associating the lid 3 with the housing 2) constrained such that it cannot be significantly displaced in a vertical direction, but is capable of rotation within the housing 2 and as such constitutes a first rotational element.

There will now be described, with reference to the figures the use of the device and a cycle which takes place upon heating of an assembled device/refill combination.

When the user first receives the device, the user will note that the lid of the device 3 includes a window 32, through which one of the numerals on the number dial 6 is visible. For a new device, the preferred number that the user will see is number “1”. This indicates to the user that the device is a new device, and is ready for its first cycle within the dishwashing machine.

Generally, the device will include a clip or mounting device (not shown), which will permit the user to attach the device to a wire basket of a dishwasher, preferably in a discrete location such as a corner. The user then need only close the door of the dishwasher and select an appropriate programme.

The device as shown in the figures hosts twelve separated doses of detergent, within twelve individual chambers.

In the start position for the very first wash, an aperture 34 in the lid 3 is generally aligned with opening 220 of the refill 200. It should be noted here that lower opening 240 (which in general is of an identical size to upper opening 220) is an outlet hole, whilst upper opening 220 is an inlet hole, so that water dispensed by a dishwasher during a washing cycle and collected by the lid 3, may wash through the exposed compartment 210, and enter into the dishwasher carrying dissolved or particulate cleaning composition from the chamber 210. The lower opening 240 need not be precisely aligned with a particular outlet hole formed in the housing 2, but instead the housing 2 may simply have one or more drainage holes which, under gravity, will allow the water and cleaning composition to exit from the device 1.

Indexing of the refill holder 4, and its associated refill package 200 so that a next chamber 210 is ready during a second washing cycle is accomplished by means of the indexing mechanism 100.

The general principles promoting the indexing of the refill 200 and holder 4, are that the indexing mechanism 100 includes a wax motor element 150. This wax motor element 150, basically consists of a wax can and piston. In preferred embodiments, the wax motor delivers up to 300 N of force. When the water in the dishwasher gets warm, the wax in the can starts to expand and pushes the piston out of the wax can. When the dishwasher cools down, strong spring 120 pushes the piston back into the wax can.

Up and down movement of the piston of the wax motor 150 is translated into a rotation of the refill cartridge 200 and its holder 4, by means of a gearing system comprising the cam, cursor, and shaft of FIGS. 4(a) and (b).

FIG. 5 shows schematically a start position of the gearing system, in which the linear element, the cursor 130, is meshed with a first rotational element in the form of cam element 140, but separated from contacting with the interior of the shaft 110 (which forms a second rotational element). In other words, the upper set of gear teeth 132 of the cursor 130 are completely separated from the parallel grooves 112 forming gear teeth of the shaft 110, but the lower set of gear teeth 134 of the cursor 130, are meshed with the gear teeth 142 of the cam 140.

Here, it should be noted that each of the portions acting as gears, include sloping teeth, for promoting gear meshing in a particular rotational direction, and gap portions for ensuring positive engagement in particular positions.

In the state shown in FIG. 5, there is no heat applied to the wax motor 150. However, within the dishwasher cycle, the conditions applied involve rising temperature sections, during a given washing programme, followed by cooling conditions. The functioning of the mechanism comprising the wax motor 150, and the various cam 140, cursor 130, and shaft 110 motions will now be described in particular with reference to FIG. 6(a) through FIG. 6(d).

FIG. 6(a) shows what happens during a first part of a heating cycle. During this heating cycle, the piston of the wax motor 150 extends so as to raise the cursor element 130, and disengage the lower gear teeth 134 of the cursor 130, from the gear teeth 142 of the cam 140. Indeed, as the cursor element 130 rises, the lowermost extent of the cursor 130 becomes completely clear of the cam element 140. At some point, during the heating cycle, sloping surfaces of the upper set of gear teeth 132 of the cursor 130, come into contact with sloping surfaces at the end of gear teeth provided by the formations 112 internally of the shaft 110. It is to be noted here that the sloping surfaces co-operate in such a manner that, as the cursor 130 may only move in the vertical plane, but the shaft 110 cannot move in the vertical plane, but instead is allowed to move rotationally in the horizontal plane, the shaft 110 is forced to rotate in the direction dictated by the sloping surfaces. In this way, as temperature rises still further, the point shown in FIG. 6(b) is reached, where a partial rotation of the shaft 110, and thereby of the associated refill holder 4, and refill 200 has occurred and, further heating simply results in the cursor 130 rising still further, and its upper gear teeth 132, which are elongated, rise vertically into gaps formed between the gear teeth 112. Therefore, during a heating cycle, a controlled amount of rotation occurs, dictated by the formation of the gearing of the upper teeth 132, and the formations 112 (which for reasons which we shall explain later gives a 6° rotation during a heating cycle) is facilitated and, thereafter, further heating does not cause further rotation, but instead causes greater meshing between the gear teeth 132, and the gaps between formations 112 on the shaft.

Thereafter, during a prolonged cooling cycle, the procedures shown in FIGS. 6(c) and 6(d) occur. Firstly, during the cooling, the cursor 132 descends vertically, as the piston of the wax motor 150, retracts under action of the spring 120. Eventually, the cursor pulls clear of the formations 112 of the shaft 110. Then, during a final phase of the cooling cycle, the lower set of teeth 134 of the cursor 130, come into contact with the gear teeth 142 of the cam 140. Here, it will be noted that both the cam 140 and the shaft 110 are linked to motion of the refill holder 4, and refill 200, and therefore the cam 140 also underwent the 6° rotation undergone during the heating cycle. Consequently, when the lower set of gear teeth 134 descend to meet the gear teeth 142 of the cam 140, they are not aligned, as they previously were. As the sloping surfaces formed on the top of the gear teeth 142, and on the base of the lower set of gear teeth 134, come into contact with each other a rotational movement of the shaft 110, refill holder 4 and refill 200 is caused. Here, the gearing of the sloping surfaces of the meshing teeth, are arranged so as to bring about a 24° rotation (again for reasons which will be described later). So that in the eventual position shown in FIG. 6(d) the lower set of gear teeth 134, are fully meshed with the gear teeth 142 of the cam 140. Again, it is of course noted that the cursor 130 is constrained to movement within the vertical plane, whilst the cam 140 and shaft 110, which are interlinked by the refill holder 4, are constrained to movement rotationally, within the horizontal plane. From the above description, it can be seen that during any given washing cycle, heating up of the wax canister forming the wax motor 150, causes extension of a piston of the wax motor 150, and brings about vertical motion of the cursor 130. This vertical motion is translated into horizontal rotational movement of the shaft by a first amount during the heating cycle, and then by a second amount, at the end of a cooling cycle. By selection of an appropriate wax within the canister, and by ensuring that gaps between gear teeth (and in particular the upper set of gears provided between the cursor 130 and the formations 112 of the shaft 110), are sufficiently elongated so that any cooling during intermediate washing cycles, does not promote sufficient retraction of the piston of the wax motor 150 under spring action 120 to cause any early meshing of the lower set of gear teeth 134, and the gear teeth 142 of the cam 140. Thereby, only at the end of a washing cycle, do these latter set of teeth mesh, and promote the further rotational movement.

The above process is illustrated schematically in FIG. 7, which shows a possible scenario of a washing cycle.

In the graph of FIG. 7, the upper line represents temperature variation over time, the intermediate solid line illustrates the expansion and contraction of a preferred wax composition over time, whilst the lower line (shown hatched) illustrates the expansion and contraction of a different wax composition. The preferred wax composition will be referred to as 36-38° C. wax, whilst the non-preferred composition will be referred to as the 38-42° C. wax.

It will be appreciated that insulation of the wax motor 150, means that tub temperatures are not immediately presented to a given wax motor, as they are not felt immediately by the wax within the wax motor. Thereby, looking at the preferred wax composition, it can be noted that once a tub temperature of 48° C. has been reached during a given washing cycle, the piston of the wax motor, may be started to be urged upwardly by the expanding wax, until, it reaches a fully expanded position. The degree of insulation provided to the wax within the wax motor 150, and the use of a so-called “lazy” composition, means that even though the temperature within the tub falls during an intermediate cool cycle to be below a nominal 36° C. temperature level, this does not translate during the short period for which it occurs (shown on the timeline as being between 45 and 60 minutes after the start of a long cycle), into sufficient retraction of the piston of the wax motor 150, to cause any problems. Indeed, because of the “lazy” properties of the wax, there is quite a time lag between the end of a cycle occurring at the 80 minute mark, and the final movement (contraction) of the wax motor 150, which does not occur until approximately the 100 minute mark. Thereby, a double actuation is avoided. Looking however at the inferior wax composition shown by the bottom line, it can be seen that use of such an inferior composition, can mean that once an activation temperature of the wax is reached, a quick reaction of the wax, during a cooling cycle, can cause piston retraction, and then, following the final heating of the tub temperature, a further activation of the wax piston can occur—leading to the “double actuation” problem.

By ensuring that movement of the chamber during the wash translates only to an additional 6°, the device can start with a fully exposed detergent chamber in which the totality of the opening 220 is within the area of the aperture 34 of the lid 3. Then during a cooling cycle, a further movement of 24° during such cooling brings the next chamber into full exposure for the following wash. Here, it will be noted that total movement of the device during a heating and cooling cycle is 30°, which of course is 1/12 of 360° and, therefore, the preferred arrangement is to have twelve chambers, with twelve doses of cleaning composition. During the 6° movement of the refill and holder during a wash, the initially fully exposed detergent chamber becomes partially closed, but still open to the flow of water. However this movement does not lead to exposure of the neighbouring chambers because there is a gap between the chambers 210 to protect neighbouring chambers from water spray ingress and therefore avoiding the problem of pre-dissolution of the detergent in the chamber for the following wash. Therefore, a dishwashing cycle begins with a fully exposed chamber right from the beginning.

The above has described, in some detail the operation of an automatic dishwasher with 6 degree and 24 degree advancement of refill cartridge during warm-up/cool down cycles.

The majority of automatic dishwashing machines do include pre-wash cycles as well as main cycles during any given overall cleaning cycle as chosen by the consumer. The pre-wash, if chosen, may be short (e.g. 5 minutes) or long (e.g. 20 minutes). In European dishwashers the water temperature is generally cold for pre-washing, whilst in the United States it is generally hot (about 49 degrees C.).

In the aforementioned and described device, the detergent is open 100% to the flow of water right from the start of the pre-wash leading to a partial dissolution of the detergent during the pre-wash cycle. Usually, the automatic indexation of the device does not activate until the temperature rises during the main wash, with final movement of the mechanism during cooling.

Whilst the use of automatic dosing devices is a major additional convenience to the user, the concentration of detergent being available during the main wash part of a cycle can be rather reduced as a result of the partial dissolution during pre-wash. This in turn leads to an overall reduced cleaning performance v.s the cleaning potential of a detergent that is dosed 100% during a main wash cycle. The “loss” of detergent in the pre-wash depends upon the length of the pre-wash and the temperature of the water as well as the wash liquor/water flow within the dishwasher. This last factor is also dependent on placement of the device within the dishwasher itself, the loading of the dishwasher and the pumping technologies applied in the dishwasher—these parameters however are generally not something considered to be within the realm of influence (or interest) of the consumer.

It is an aim of preferred embodiments of the invention to provide a means for preventing or obstructing water flow into an open chamber of the device during a pre-wash cycle.

According to a first aspect of the invention, there is provided a multi-dosing detergent delivery device, the device comprising a housing for receiving therein, in use, a cartridge having a plurality X of chambers each accommodating a detergent composition, a directing means to direct, in use, wash liquor selectively into a selected chamber of the cartridge to contact the detergent composition therein, an outlet to allow the detergent loaded wash liquor to exit the device and indexing means for automatic movement of said cartridge, in use, relative to said directing means, the device further comprising means for blocking or obstructing passage of water/wash liquor from said directing means to the selected chamber during part of a wash cycle, wherein said means for blocking or obstructing passage of water/wash liquor comprises a shutter mechanism for blocking/obstructing during part of a wash cycle.

Said shutter mechanism is preferably arranged to block entry of water/wash liquor into the selected chamber prior to a heating phase of a washing cycle and is arranged to progressively allow passage of water/wash liquor to the selected chamber as said indexing means advances said cartridge relative to said directing means.

Most preferably, said shutter mechanism comprises a resiliently biased pivot arm driven by said indexing means. Said shutter mechanism may comprises a head portion of the pivot arm being arranged to selectively block an entry hole of the device and an actuator portion of the pivot arm that is driven by said indexing means.

Preferably, said actuator portion is driven, in use, by motion of a holder of the cartridge. Said holder may be provided with engagement portions for driving said actuator portion as said holder rotates.

The shutter mechanism is preferably provided internally of a lid of the device.

The shutter mechanism preferably comprises a pivot arm, a spring, a pivot fixing and a pivot seat, wherein the pivot seat forms part of the lid of the device.

Examples of embodiments of the present invention will now be described with the aid of the accompanying drawings, in which:

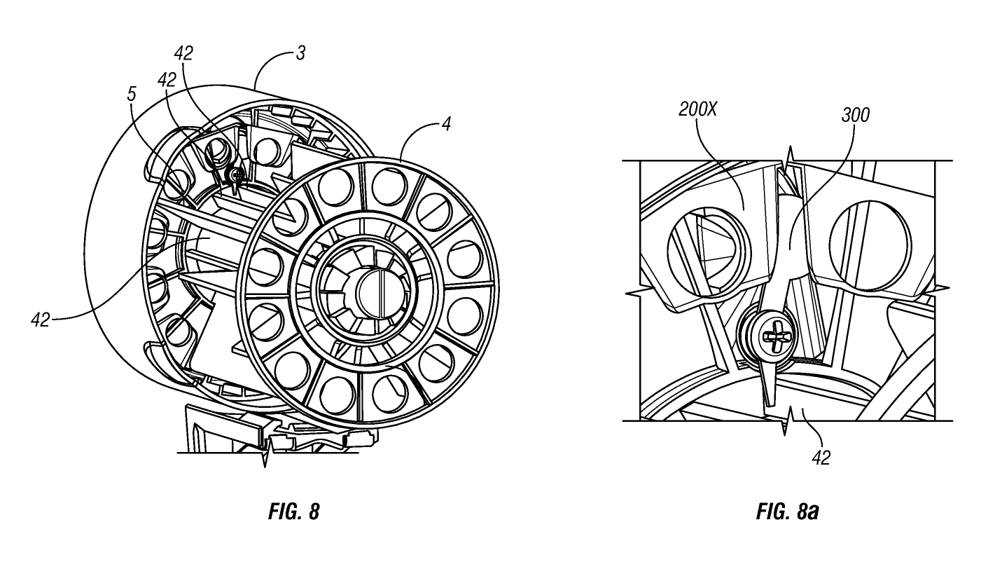

FIGS. 8 and 8(A) show, respectively, an exploded schematic internal view of a multi-dosing delivery device including a shutter mechanism for blocking an entry hole of the device and a detailed view of said shutter mechanism, the shutter is shown in both figures as being in a closed position;

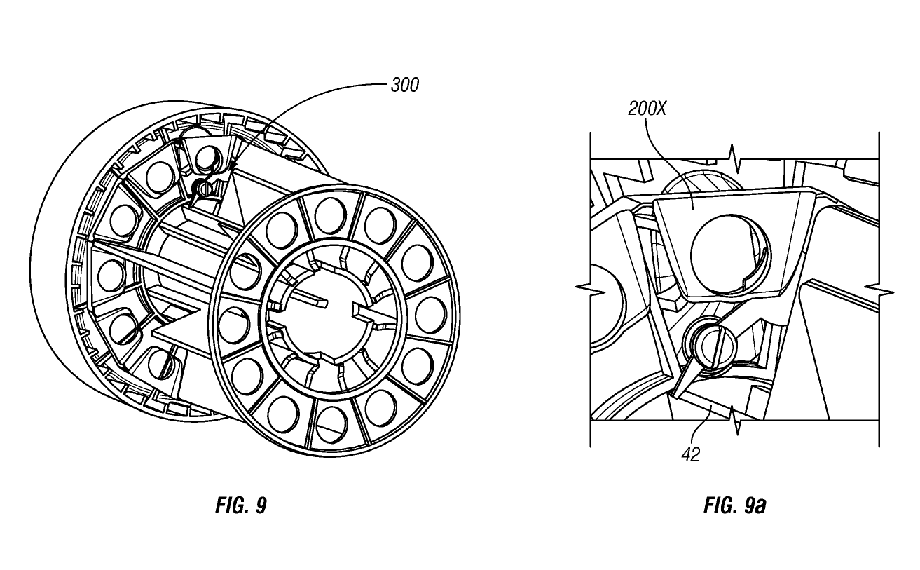

FIGS. 9 and 9(A) show, respectively, an exploded schematic internal view of the shutter mechanism, in these figures the shutter is shown as being in an open position; and

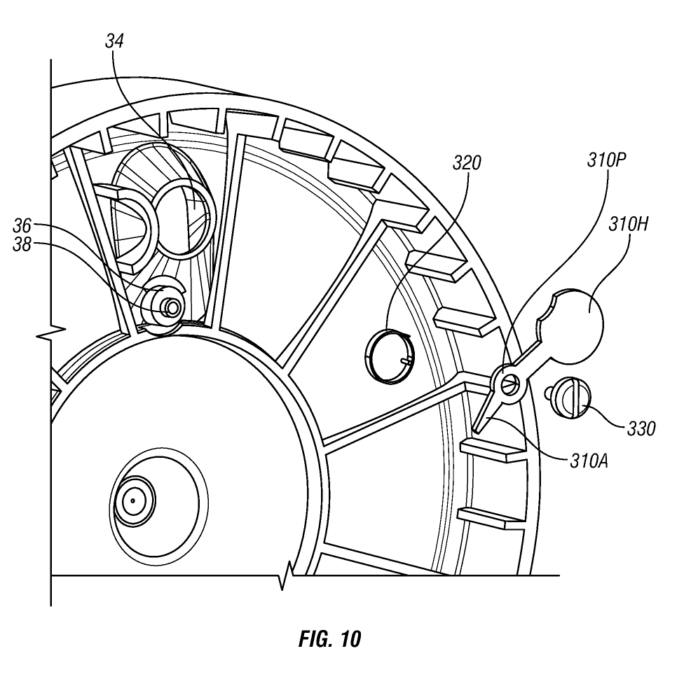

FIG. 10 shows detail of the shutter mechanism.

With a view to mitigating the problems of detergent loss during pre-wash, a mechanical shutter is provided between the refill and the water entry hole of the lid. This serves to block the water flow into the active detergent chamber during the pre-wash.

In FIGS. 8/8A and 9/9A there is shown schematically the refill holder 4, the lid 3, and a partial representation 200× of a refill cartridge 200 representing the position of where the entry holes of chambers 210 of the cartridge would appear within an assembled device. In this device, it is assumed that details of the device not relating to the specific improvements described hereinafter are the same or equivalent to those of the prior art device described previously in relation to FIGS. 1 through 7.

FIGS. 8/8A and 9/9A omit many features in order to properly show the positioning of device improvements in the form of a shutter mechanism 300.

Referring to FIG. 10 of the drawings, the shutter mechanism 300 comprises a pivot arm 310, a resilient biasing means in the form of a torsion spring 320 with a pair of tabs at each end, and a threaded pivot fixing 330, which may be a screw.

The pivot arm 310 has an enlarged head portion 310H, a pivot hole 310P and an actuator portion 310A

The lid 3 has a shutter seat 36 and, formed centrally on that, is a pivot shaft 38 that is internally threaded.

The shutter mechanism, shown in exploded form in FIG. 10, is assembled by seating the torsion spring 320 onto the shutter seat 36, where one end tab of the spring locates with a corresponding formation (not shown) of the seat 36 so as to anchor the torsion spring at one end. The pivot arm 310 fits onto the shaft 38 and is fixed in position by pivot fixing 330 screwing into the internally threaded hole of the pivot shaft. The other end tab of the torsion spring conveniently bears against part of the pivot arm 310 so as to hold the assembly in a “closed” position as shown in FIG. 8, where the enlarged head 310H of the pivot arm completely covers the entry hole 34 of the lid 3 so as to block water/wash liquor entry into the device.

Having described the assembly of the shutter mechanism itself, the co-operation of the shutter mechanism with the refill cartridge holder 4 will now be described.

As discussed previously in relation to the prior art mechanism, the holder 4 carries a cartridge 200. The holder 4 has a number of fingers 5 that co-operate with spaces formed in the cartridge 200 to define the position of an assembled cartridge and holder. This in turn dictates the position in which the entry holes of each chamber will lie within a final assembled device.

In the improvement which we describe here, the holder 4 also carries a series of engagement portions in the form of vanes 42 extending from a central hub. These vanes 42 are spaced around the hub equally and there are as many vanes as there are chambers 210 within a given refill cartridge 200. The vanes are placed at 30 degree intervals in a twelve chamber device and their positioning will now be described.

As mentioned already, it is an object of embodiments of the invention to obstruct water entry into chambers 210 of a cartridge during a pre-wash stage so as to mitigate the problem of detergent being diluted at too early a stage in a washing cycle. Hence, the shutter mechanism is arranged so that during a pre-wash stage the hole 34 of the lid 3 is covered by the enlarged head 310H of the pivot arm 310. This state is represented in FIG. 8/8A. Looking at the enlarged view of FIG. 8A, it can be seen that vane 42 is just at the point of engagement and resting against the actuator portion 310A of pivot arm 310 in this condition and that the action of the torsion spring 320 is keeping the hole 34 covered.

The holder 4 may be seen as an extension of the indexing means of the prior art device as it moves under direct influence of the indexing mechanism. As the wax motor in the device heats up, denoting a main wash cycle, the holder 4 will rotate in accordance with the description of the prior art device. This rotation will cause the vane 42 to bear against the actuator portion 310A of the arm 310 and push against it so as to cause the pivot arm 310 to rotate upon pivot shaft 38. As this rotation proceeds, more and more of the hole 34 becomes uncovered so as to allow water/wash liquor to enter the aligned chamber 210 of the cartridge 200. So that in due course, the state shown in FIGS. 9/9A is reached where the entire area of the hole 34 is uncovered.

Whilst not shown in the figures, it will be appreciated that as the holder 4 continues to rotate, the actuator portion 310A of the pivot arm 310 will, in due course, be released by the vane 42 and spring action will cause the hole 34 to be covered once again. This is preferably arranged to occur or subsequent to a cooling cycle of the device—but may of course be arranged as desired by the device engineer.

The skilled man will realise that by appropriate variation of the pivot arm length and position and the vane 42 positioning, a device may be provided in which any desired timing of opening of the hole versus temperature may be provided so as to account for, for instance, the fact that pre-wash cycles in the united states may have heated water as opposed to cold water.

Various modifications to the device are of course possible, without departing from the overall inventive concepts. For instance, spring type need not be torsion type and dimensions and biasing of the pivot arm can be varied. Also, whilst the mechanism is preferably driven by motion of a cartridge holder 4, it may be otherwise driven—for instance, by formations provided on the cartridge 200 itself.

While the description refers to blocking the entry hole (34) of the device with the enlarged head 310H, it will be appreciated that the blocking may take place over the entry hole 220 of the selected cartridge chamber 210—although this may be less preferred as there may be a danger of water then being able to access non-selected chambers.

While the description of the device specifically refers back to use in the prior device described in relation to FIGS. 1 to 7, it will be appreciated that the principles may be applied for use in other devices. Further, whilst the prior device referred to motion of the cartridge being in a two stage, 6 degree, 24 degree action, it will be appreciated that the means for blocking or obstructing passage of water/wash liquor as described in the improvement herein need not be so restricted and the period during which the hole is blocked may be anything from a very small percentage of a wash cycle up to a large percentage by simple variation of placement and dimensions.

1. A multi-dosing detergent delivery device, the device comprising a housing for receiving therein, in use, a cartridge having a plurality of chambers each accommodating a detergent composition, a directing means to direct, in use, wash liquor selectively into a selected chamber of the cartridge to contact the detergent composition therein, an outlet to allow the detergent loaded wash liquor to exit the device and indexing means for automatic movement of said cartridge in use relative to said directing means, the device further comprising means for blocking or obstructing passage of water/wash liquor from said directing means to the selected chamber during part of a wash cycle, wherein said means for blocking or obstructing passage of water/wash liquor comprises a shutter mechanism for blocking/obstructing passage during part of a wash cycle.

2. A device according to claim 2, wherein said shutter mechanism is arranged to block entry of water/wash liquor into the selected chamber prior to a heating phase of a washing cycle and is arranged to progressively allow passage of water/wash liquor to the selected chamber as said indexing means advances said cartridge relative to said directing means.

3. A device according to claim 2, wherein said shutter mechanism comprises a resiliently biased pivot arm driven by said indexing means.

4. A device according to claim 2, wherein said shutter mechanism comprises a head portion arranged to selectively block an entry hole of the device and an actuator portion which is driven by said indexing means.

5. A device according to claim 4 wherein said actuator portion is driven, in use, by motion of a holder of the cartridge.

6. A device according to claim 5, wherein said holder is provided with engagement portions for driving said actuator portion as said holder rotates.

7. A device according to claim 2, wherein said shutter mechanism is provided internally of a lid of the device.

8. A device according to claim 2, wherein said shutter mechanism comprises a pivot arm, a spring and pivot fixing and a pivot seat, wherein the pivot seat forms part of said lid.

9. (canceled)
